(19) United States
(12) Patent Application Publication
(10) Pub. No.: US 2017/0309463 A1
(43) Pub. Date: Oct. 26, 2017

(54) SYSTEMS AND METHODS FOR TRACE CHEMICAL DETECTION USING DUAL PHOTOIONIZATION SOURCES

(71) Applicant: Morpho Detection, LLC, Newark, CA (US)

(72) Inventor: Andrey N. Vilkov, Aliso Viejo, CA (US)

(21) Appl. No.: 15/135,679

(22) Filed: Apr. 22, 2016

(51) Int. Cl. H01J 49/16; G01N 27/62; H01J 49/04; H01J 49/26

(52) U.S. Cl. CPC H01J 49/161; H01J 49/26; G01N 27/622; H01J 49/0409

(57) ABSTRACT

A dual source ionizer is provided. The dual source ionizer includes a first photoionization source configured to emit low flux ultraviolet (UV) light to generate primarily NO₃⁻ ions, and a second photoionization source configured to emit high flux UV light to generate primarily ions other than NO₃⁻ ions.

### BACKGROUND

The field of the disclosure relates generally to explosive trace detection (ETD) systems and, more particularly, to systems and methods for trace detection using dual ionization sources.

Various technologies exist for detection of substances of interest, such as explosives and illicit drugs. Some trace detection technologies use spectrometric analysis of ions formed by ionization of vapors of substances of interest. Spectrometric analysis includes ion mobility spectrometry and mass spectrometry, for example, both of which are common in trace detection.

Ionization is a process by which electrically neutral atoms or molecules acquire a negative or positive charge by gaining or losing electrons, by undergoing a reaction, or by combining with an adduct that imparts a positive or negative charge. The electrically charged atoms or molecules are referred to as ions. Ionization occurs when sufficiently energetic charged particles or radiant energy travel through gases. For example, ionization occurs when an electric current is passed through a gas, if the electrons constituting the current have sufficient energy to force other electrons from the neutral gas molecules. Ionization also occurs, for example, when alpha particles and electrons from radioactive materials travel through a gas. Ionization can also occur if a photon of sufficiently high energy intercepts with molecules. Numerous ionization sources are used today for a variety of purposes.

### BRIEF DESCRIPTION

In one aspect, a dual source ionizer is provided. The dual source ionizer includes a first photoionization source configured to emit low flux ultraviolet (UV) light to generate primarily NO₃⁻ ions, and a second photoionization source configured to emit high flux UV light to generate primarily ions other than NO₃⁻ ions.

In another aspect, a method of ionizing a gas is provided. The method includes ionizing the gas using a first photoionization source that emits low flux ultraviolet (UV) light, and ionizing the gas using a second photoionization source that emits high flux UV light.

In yet another aspect, a trace detection system is provided. The trace detection system includes a chamber configured to contain a gas composed of at least a vapor of a chemical substance sample, a first photoionization source configured to emit low flux ultraviolet (UV) light to generate primarily NO₃⁻ ions from the gas, and a second photoionization source configured to emit high flux UV light to generate primarily ions other than NO₃⁻ ions from the gas.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an exemplary trace detection system.

FIG. 2 is a diagram of an exemplary dual source ionizer for use in the trace detection system shown in FIG. 1.

FIGS. 3A and 3B show multiple graphs demonstrating a decreased signal-to-noise ratio for detection of RDX and Nitroglycerine due to increased ion noise at higher UV flux.

FIG. 4 shows multiple graphs demonstrating an increased signal-to-noise ratio for detection of TATP due to increased ion signal at higher UV flux.

FIG. 5 is a flow diagram of an exemplary method of ionizing gas.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

The embodiments described herein facilitate using a dual source ionizer to ionize a gas. The dual source ionizer includes a first photoionization source configured to emit low flux ultraviolet (UV) light to generate primarily NO₃⁻ ions. The dual source ionizer also includes second photoionization source configured to emit high flux UV light to generate primarily ions other than NO₃⁻ ions. The first and second photoionization sources may be, for example, krypton discharge lamps.

During ionization in ambient atmospheric air, ionization sources typically produce significant amounts of ozone that leads to subsequent formation of NOₓ⁻ ions. The number of NOₓ⁻ ions formed from atmospheric air varies among ionization sources from high for electrical discharge ionization methods to low for photo-, x-ray, and radioactive sources. High amounts of ambient NOₓ⁻ ions may suppress the sensitivity of explosive trace detection (ETD) systems for nitrate-based explosives, including ammonium nitrate (AN) and urea nitrate (UN). For example, the atmospheric NO₃⁻ ion overlaps in chemical composition with the nitrate NO₃⁻ ion from nitrate-based explosives, decreasing the sensitivity for nitrate detection. The NOₓ⁻ ions are also helpful, as adduct ions, in detection of a variety of other explosives, including research department explosive (RDX), pentaerythritol tetranitrate (PETN), ethylene glycol dinitrate (EGDN), nitroglycerin (NG), Tetryl, and high melting explosive (HMX), among others. These other explosives are sometimes referred to as non-nitrate-based explosives. Non-nitrate-based explosives also include nitrate-containing compounds that are not detected by their respective nitrate ions. Detection of such explosives using NO₃⁻ adduct ions can be very sensitive and selective, and is an inexpensive alternative for commonly used dopants, including chlorine-containing chemical substances.

In atmospheric air, NOₓ⁻ ions are formed by a series of chemical reactions referred to as pathways. The formation of ozone is a precursor to the formation of NOₓ⁻ ions. Ozone is formed readily by breaking molecular oxygen, O₂, into atomic oxygen, O, by radiation with an energy higher than the oxygen chemical bond, which is 5.15 electron volts (eV), according to a first pathway. The radiation may be electromagnetic, such as ultraviolet (UV), X-ray, and gamma-ray, or particulate, such as alpha-particle and electron beams. An energy of 6.25 eV or higher is sufficient to excite ground state of nitrogen molecules N₂ to form the lowest A³Σᵤ⁺ metastable state, which reacts with diatomic oxygen O₂ and then forms ozone, O₃, according to a second pathway.

In electrical discharge systems, the production of ozone and NOₓ⁻ ions can be controlled through choice of conditions, such as flow rate and humidity. The production of NOₓ⁻ ions may also be controlled through use of ion suppressants. Use of these techniques in ETD systems makes the systems more complicated, less reliable, more costly, and heavy.

In atmospheric air, NO₃⁻ ions may be formed using UV light through a series of chemical reactions. The nitrogen atom in an NO₃⁻ ion may originate from one of three possible sources: i) molecular nitrogen (N₂) (which has a natural concentration in atmospheric air of approximately 78%), ii) nitrogen dioxide (NO₂) (which has a natural concentration in atmospheric air of approximately 100 parts per billion (ppb)), and iii) nitric oxide (NO) (which has a natural concentration in atmospheric air of approximately 50 parts per billion (ppb)).

One exemplary source of UV light is a krypton discharge lamp. A krypton discharge lamp provides two emitting bands in the wavelength region around 123 and 116 nanometers (nm). Molecular nitrogen has a UV absorption spectrum that includes an absorption band system from 145 to 112 nm. These are referred to as the Lyman-Birge-Hopfield bands, and are associated with a forbidden ground-state transition. Because there is no overlap between bands of emitted UV light of a krypton discharge lamp, and the UV absorption spectrum of molecular nitrogen, no dissociation of molecular nitrogen occurs when using a krypton discharge lamp. Thus, if a krypton discharge lamp is used as a UV source, only NO and NO₂ modulates may serve as suppliers of nitrogen atoms.

Typical pathways for producing NO₃⁻ ions include the following:

O₃⁻+NO₂→NO₃⁻+O₂ (1)

O₂⁻+NO→NO₃⁻ (2)

O₃⁻+CO₂→CO₃⁻+O₂ (3) (a)

CO₃⁻+NO₂→NO₃⁻+CO₂ (b)

According to the above pathways, oxygen ions (O₂) and ozone ions (O₃) are also precursors for the formation of NO₃⁻ ions. Oxygen and ozone ions are formed by breaking molecular oxygen, O₂, into atomic oxygen, O, with an energy higher than the 5.15 eV oxygen chemical bond. According to a second pathway for producing oxygen and ozone ions, an energy of 6.25 eV or higher is sufficient to excite the ground state of nitrogen molecules N₂ to form the lowest A³Σᵤ⁺ metastable state, which reacts with molecular oxygen O₂ and then forms ozone, O₃.

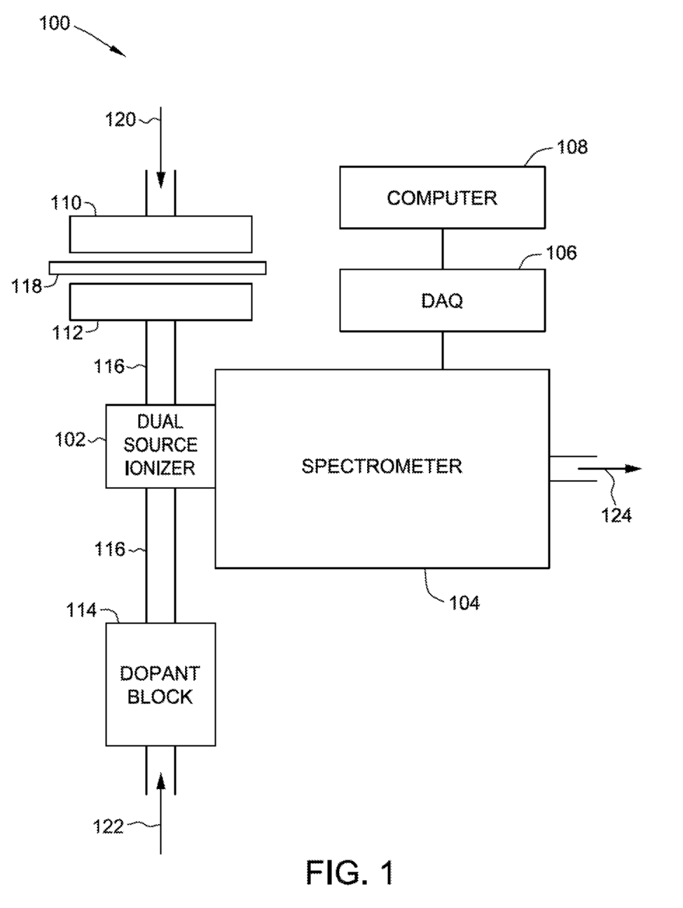

In the systems and methods described herein, a dual source ionizer is capable of operating in a first, low flux UV mode and a second, high flux UV mode. FIG. 1 is a block diagram of an exemplary trace detection system 100. Trace detection system 100 includes a dual source ionizer 102, a spectrometer 104, a data acquisition system (DAQ) 106, a computer 108, a first heating device 110, a second heating device 112, a dopant block 114, and ducts 116.

A sample swab 118, on which a chemical substance sample is present, is placed between first heating device 110 and second heating device 112. In alternative embodiments, the chemical substance sample may be introduced by any other suitable means, including direct intake of vapor of the chemical substance sample and any other device suitable for vaporizing the chemical substance sample. Air is drawn from a first air intake 120 over sample swab 118. Heat generated by first heating device 110 and second heating device 112 causes the chemical substance sample on sample swab 118 to vaporize and separate from sample swab 118. The air from first air intake 120 carries the vapor molecules through duct 116 into dual source ionizer 102. In alternative embodiments, first heating device 110 and second heating device 112 are replaced by another suitable device or method of vaporizing the chemical substance sample, including laser desorption, radio frequency heating, and microwave heating.

In certain embodiments, air is also drawn from a second air intake 122 across dopant block 114, releasing dopant and carrying it to dual source ionizer 102. Dopant present in dual source ionizer 102 alters electrochemical characteristics of the vapor molecules, which may facilitate improving the efficiency of the ionization process.

Dual source ionizer 102 ionizes the vapor molecules, the ions of which are analyzed by spectrometer 104. As described herein, in the exemplary embodiment, dual source ionizer 102 includes a first photoionization source that operates in a low flux mode and a second photoionization source that operates in a high flux mode. The first photoionization source and the second photoionization source may be separate photoionization sources, or may be the same photoionization source that is capable of operating in both the low and high flux modes. In the exemplary embodiment, both the first and second photoionization sources are UV light sources. Further, each UV light source may be, for example, a krypton discharge lamp.

Dual source ionizer 102 carries out ionization inside the chamber where the vapor molecules, dopants, and ambient air are present. In certain embodiments, each photoionization source operates within its own, isolated volume within the chamber. In other embodiments, the two photoionization sources operate within a single volume within the chamber. Further, as noted above, the first and second photoionization sources may be the same photoionization source in some embodiments.

Ionization is carried out over a scan duration. Within the scan duration, there is at least one period of time where only NOₓ⁻ ions are desirable for the purpose of trace detection, such as, for example, for detection of non-nitrate-based explosives. During this period, the second photoionization source that generates high flux UV light is disabled, which inhibits the relative production of non-NOₓ⁻ ions. Further, the second photoionization source is enabled and ionizes the vapor molecules using high flux UV light.

Also within the scan duration, there is at least one period of time where NOₓ⁻ ions are desirable for the purpose of trace detection, such as, for example, for detection of some explosives using NOₓ⁻ ions as adducts. During this period, the first photoionization source is enabled and generates low flux UV light. The low flux UV light ionizes the vapor molecules and results in formation of ozone and NOₓ⁻ ions. In certain embodiments, the first photoionization source is enabled for multiple periods within the scan duration. In certain embodiments, the first photoionization source is enabled for a single period. During this period, in certain embodiments, the second photoionization source is disabled. In other embodiments, the second photoionization source remains enabled while the first photoionization source is enabled. In certain embodiments, the enabling and disabling of the first and second photoionization sources are controlled by controller using a pulse signal, such as a square wave, controlling a switch.

Spectrometer 104 carries out spectrometry to screen the chemical substance for certain target chemical substances, such as, for example, explosives and drugs. Spectrometer 104 may be, for example, a mass spectrometer or an ion mobility spectrometer. Results of the spectrometry carried out by spectrometer 104 on the ions are collected by DAQ 106 and disseminated to computer 108, where a detection or a failure to detect is indicated.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

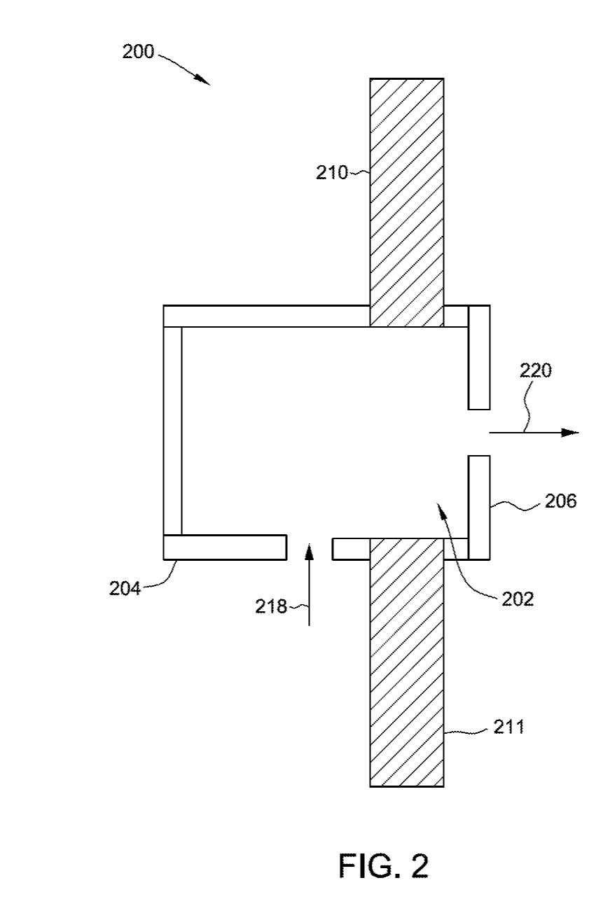

FIG. 2 is a diagram of exemplary dual source ionizer 200 for use in trace detection system 100 (shown in FIG. 1). Dual source ionizer 200 includes a volume 202 at least partially defined by a housing 204 and an aperture plate 206, a first ultraviolet (UV) lamp 210, and a second UV lamp 211. First and second UV lamps 210 and 211 may be, for example, krypton discharge lamps. Further, in some embodiment, first and second UV lamps 210 and 211 are the same UV lamp.

During operation, gases 218 enter volume 202 and ions 220 exit. Depending upon a volume of a UV photoionization source (e.g., first and second UV lamps 210 and 211), an intensity of UV light, and a gas flow rate through volume 202, there are two possible modes of operation. Specifically, in the exemplary embodiment, first UV lamp 210 emits low flux UV light for the first mode and second UV lamp 211 emits high flux UV light for the second mode.

In the first mode, with first UV lamp 210 emitting low flux UV light, the number of UV photons is smaller than the number of available nitrogen-containing NO₃⁻ ion precursors. Because of the relatively high electron affinity of the NO₃⁻ ion (e.g., approximately 3.7-3.9 eV), a certain delay time after initiation of the first mode (typically on a millisecond scale), substantially all ions within volume 202 will be converted into NO₃⁻ ions. The first mode facilitates negative ionization.

In the second mode, with second UV lamp 211 emitting high flux UV light, the number of UV photons is greater than the number of available nitrogen-containing NO₃⁻ ion precursors. As a result, the concentration of NO₃⁻ ions will be limited to approximately 150 ppb, and the remaining available electrons will be used to ionize a plurality of chemical compounds. The second mode facilitates positive ionization.

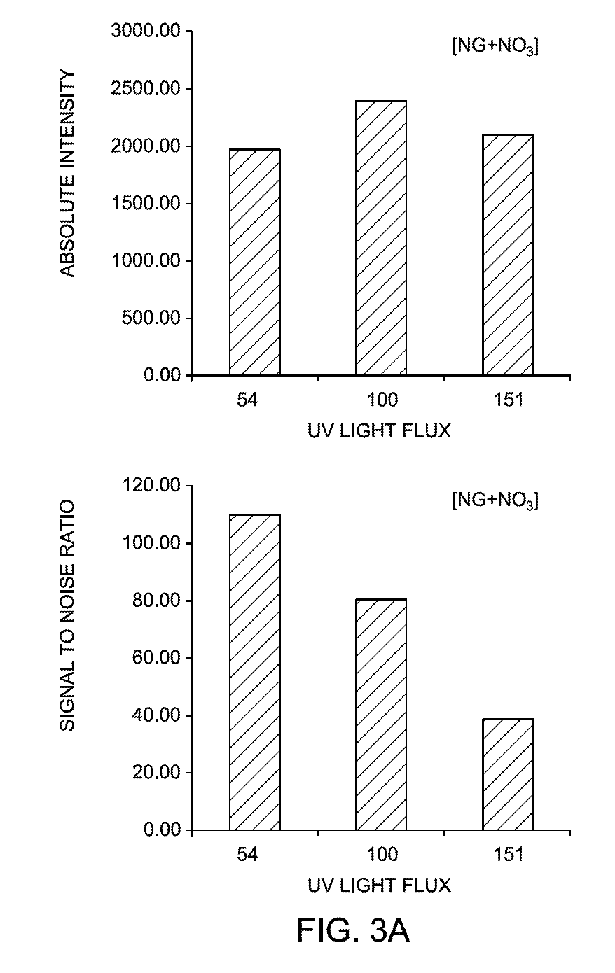

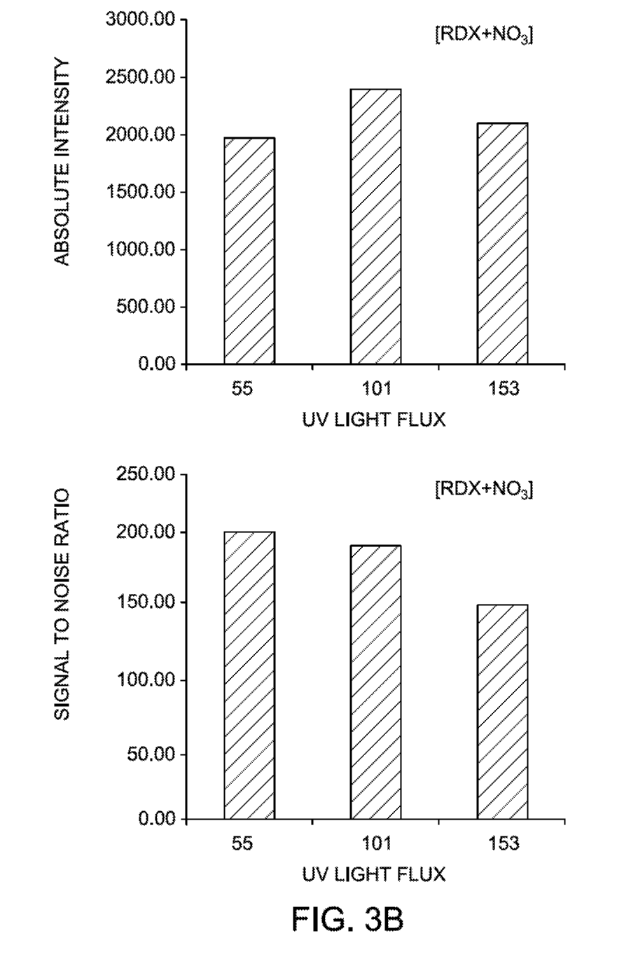

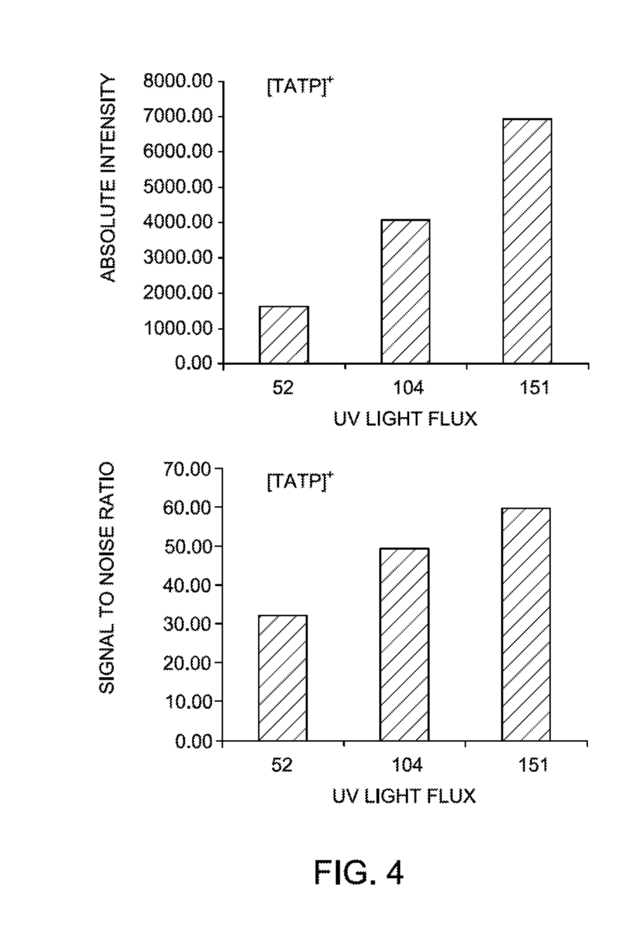

By way of example, FIGS. 3A and 3B show that signal intensities of [NG+NO₃]⁻ ions and [RDX+NO₃]⁻ ions, respectively, are limited by an available number of NO₃⁻ ion precursors. Further increases in flux lead only to ionization of background interferents, consequently reducing signal-to-noise ratio for ions of interest. In contrast, FIG. 4 shows a positive trend for signal intensities of TATP ions upon an increase of UV light flux in a positive mode, and consequently increased signal-to-noise ratio for detection of TATP.

In one example, a volume of each of first UV lamp 210 and second UV lamp 211 is approximately 1 cubic centimeter (1 cm³). The number of molecules of air at room temperature in 1 cm³ will be approximately 2.5×10¹⁹. Accordingly, the number of available nitrogen-containing precursors in 1 cm³ will be approximately 2.5×10¹⁹×(150×10⁻⁹), or 3.75×10¹². Accordingly, at a characteristic flow rate of 1 cm³ per second, the first operational mode will take place with UV light flux of approximately 3.75×10¹² photons per second.

Without attenuation, a krypton discharge lamp generally outputs at least 10¹⁵ photons per second. Accordingly, to achieve the first mode, the UV light output of first UV lamp 210 may be attenuated. For example, the UV light output of first UV lamp 210 may be attenuated to be less than approximately 3.75×10¹² photons per second, or may be attenuated to be in a range between approximately 3.75×10¹² photons per second and 1.0×10¹⁴ photons per second. To achieve the second mode, the UV light output may be unattenuated, resulting in a flux on the order of 10¹⁵ photons per second.

Introducing dopant molecules (e.g., using dopant block 114 (shown in FIG. 1)) into volume 202 facilitates varying the UV flux value between the first mode and the second mode. A bordering UV flux value depends upon the concentration of dopant molecules and their cross-sections. Typically, atmospheric pressure photoionization sources show ionization of approximately 10⁻³ to 10⁻⁵ ions per photon.

The desired level of UV attenuation may be achieved, for example, using UV light filters made out of various materials (e.g., magnesium, calcium fluoride) where the attenuation level is proportional to a thickness of the UV filter. Alternatively, the attenuation may be achieved electronically by limiting a discharge current of the krypton discharge lamp.

For the first, low flux mode, the use of NO₃⁻ ions results in a reduction of ions created from background interferents, while allowing the ionization of selected explosive compounds, making the NO₃⁻ ion an important selective reactant ion species. For example, Nitrate ions form ionic clusters [M+NO₃]⁻ with a number of explosive compounds such as EGDN, RDX, NG and PETN, and also generate the formation of [M−H]⁻ ion for TNT and [M−NO₂]⁻ for Tetryl. Based on thermal profile differences between these explosives and true nitrates allows for direct detection of nitrate salts such as ammonium nitrate (AN) and urea nitrate (UN), even at the low flux settings of the first mode.

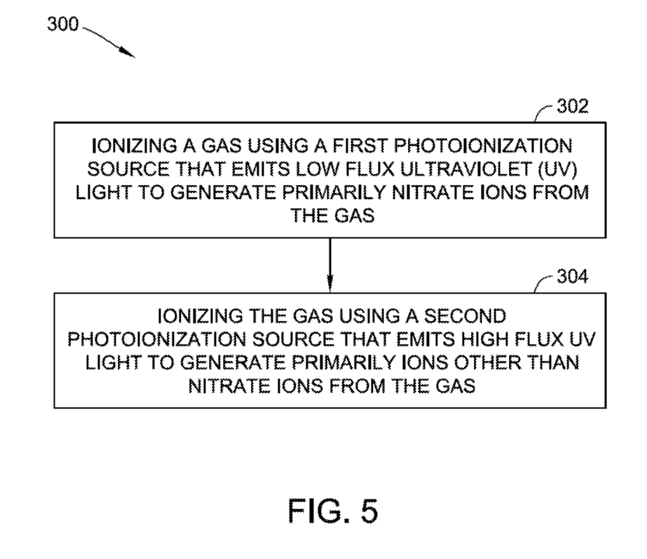

FIG. 5 is a flow diagram of an exemplary method 300 of ionizing a gas. At a first ionization step 302, the gas is ionized using a first photoionization source, such as first UV lamp 210. The first photoionization source emits low flux UV light to generate primarily NO₃⁻ ions from the gas. At a second ionization step 304, the gas is ionized using a second photoionization source, such as second UV lamp 211. The second photoionization source emits high flux UV light to generate primarily ions other than NO₃⁻ ions.

The systems and methods described herein facilitate using a dual source ionizer to ionize a gas. The dual source ionizer includes a first photoionization source configured to emit low flux ultraviolet (UV) light to generate primarily NO₃⁻ ions. The dual source ionizer also includes second photoionization source configured to emit high flux UV light to generate primarily ions other than NO₃⁻ ions. The first and second photoionization sources may be, for example, krypton discharge lamps.

Exemplary embodiments of methods, systems, and apparatus for dual source ionizers are not limited to the specific embodiments described herein, but rather, components of systems and/or steps of the methods may be utilized independently and separately from other components and/or steps described herein. For example, the methods may also be used in combination with other non-conventional dual source ionizer, and are not limited to practice with only the systems and methods as described herein. Rather, the exemplary embodiment can be implemented and utilized in connection with many other applications, equipment, and systems that may benefit from increased efficiency, reduced operational cost, and reduced capital expenditure.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A dual source ionizer comprising:
a first photoionization source configured to emit low flux ultraviolet (UV) light to generate primarily NO₃⁻ ions; and
a second photoionization source configured to emit high flux UV light to generate primarily ions other than NO₃⁻ ions.

2. The dual source ionizer of claim 1, further comprising a controller communicatively coupled to said first and second photoionization sources and configured to selectively disable said second photoionization source for a period of time while said first photoionization source is enabled.

3. The dual source ionizer of claim 1, wherein at least one of said first photoionization source and said second photoionization source comprises a krypton discharge lamp.

4. The dual source ionizer of claim 1, wherein the first and second photoionization sources are the same photoionization source.

5. The dual source ionizer of claim 1, wherein the first and second photoionization sources are separate photoionization sources.

6. The dual source ionizer of claim 1, wherein the first photoionization source is configured to emit UV light having a flux less than approximately 3.75×10¹² photons per second.

7. The dual source ionizer of claim 1, wherein the first photoionization source is configured to emit UV light having a flux in a range between approximately 3.75×10¹² photons per second and 1.0×10¹⁴ photons per second.

8. The dual source ionizer of claim 1, wherein the second photoionization source is configured to emit UV light having a flux on the order of 10¹⁵ photons per second.

9. A method of ionizing a gas, the method comprising:
ionizing the gas using a first photoionization source that emits low flux ultraviolet (UV); and
ionizing the gas using a second photoionization source that emits high flux UV.

10. The method of claim 9, further comprising selectively disabling the second photoionization source for a period of time while the first photoionization source is enabled.

11. The method of claim 9, wherein ionizing the gas using a first photoionization source comprises ionizing the gas using a krypton discharge lamp.

12. The method of claim 9, wherein ionizing the gas using a second photoionization source comprises ionizing the gas using a krypton discharge lamp.

13. The method of claim 9, wherein ionizing the gas using a first photoionization source and wherein ionizing the gas using a second photoionization source comprise ionizing the gas using the same photoionization source.

14. The method of claim 9, wherein ionizing the gas using a first photoionization source and wherein ionizing the gas using a second photoionization source comprise ionizing the gas using separate photoionization sources.

15. The method of claim 9, wherein ionizing the gas using a first photoionization source comprises ionizing the gas using a first photoionization source that emits UV light having a flux less than approximately 3.75×10¹² photons per second.

16. The method of claim 9, wherein ionizing the gas using a first photoionization source comprises ionizing the gas using a first photoionization source that emits UV light having a flux in a range between approximately 3.75×10¹² photons per second and 1.0×10¹⁴ photons per second.

17. The method of claim 9, wherein ionizing the gas using a second photoionization source comprises ionizing the gas using a second photoionization source that emits UV light having a flux on the order of 10¹⁵ photons per second.

18. A trace detection system comprising:
a chamber configured to contain a gas composed of at least a vapor of a chemical substance sample;
a first photoionization source configured to emit low flux ultraviolet (UV) light to generate primarily NO₃⁻ ions from the gas; and
a second photoionization source configured to emit high flux UV light to generate primarily ions other than NO₃⁻ ions from the gas.

19. The trace detection system of claim 18, further comprising a spectrometer configured to screen ions generated from the gas for both nitrate-based explosives and for non-nitrate-based explosives.

20. The trace detection system of claim 18, further comprising a controller communicatively coupled to said first and second photoionization sources and configured to selectively disable said second photoionization source for a period of time while said first photoionization source is enabled.
